(19) United States
(12) Patent Application Publication
(10) Pub. No.: US 2005/0091430 A1
(43) Pub. Date: Apr. 28, 2005

(54) [INTEGRATED DEVICE WITH CARD-READING FUNCTION AND INSTRUCTION-INPUT FUNCTION AND INTEGRATED CHIP THEREIN]

(76) Inventor: YING-CHING LEE, TAIPEI COUNTY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,738

(22) Filed: Jan. 8, 2004

(30) Foreign Application Priority Data
Oct. 23, 2003 (TW) 92218830

(51) Int. Cl. G06F 13/00

(52) U.S. Cl. 710/62; 711/115; 710/305

(57) ABSTRACT

A device that integrates the card-reading function and the instruction-input function is provided. The device includes a printed circuit board (PCB). The PCB has a transmission interface electrically coupled to an external device, a memory card connector receiving input from a memory card, a human-machine interface module for storing the outside-instruction, and an integrated chip. The integrated chip has an interface engine electrically coupled to the transmission interface, a memory card interface module electrically coupled to the memory card connector, a common input/output module electrically coupled to the human-machine interface module, a memory module and a micro-controller.

### CROSS REFERENCE TO RELATED APPLICATIONS

This application claims the priority benefit of Taiwan application serial no.92218830, filed on Oct. 23, 2003.

### BACKGROUND OF INVENTION

1. Field of the Invention

The present invention is generally related to an integration of electronic components and products. More particularly, the present invention relates to a device that integrates a card-reading function and an instruction-input function and an integrated chip therein.

2. Description of the Related Art

The emergence of a flash memory module has gradually became a replacement for the conventional floppy disk and compact disk (CD) because the flash memory module consumes less power, and with high reliability, high storing capacity and high speed. However, there are many different versions of the flash memory module, for example, PCMCIA, CF, SM, MMC, SD, MS and xD cards that are currently existing in the market and all have their own users. As a result, different manufacturers implement different versions of the flash memory module and inconvenience can be caused due to the incompatibility of these modules. This is especially the case in multimedia usage (including JPEG and MPEG), in which information communication is limited between these modules causing the inconvenience, and is also the case for many other electronic products. Moreover, desktop computers can have a built-in or an external card reader device to support for the multiple versions of the flash memory module. This causes the complexities of the connections and the number of devices needed.

The built-in card reader device is implemented within a computer system and communicated with the computer system via a transmission interface such as IDE or ATAPI. But, the built-in card reader device is very limited in function that it can only be used as an access device for a memory card.

On the other hand, the external card reader device is coupled to a computer system via a universal serial bus (USB) or IEEE1394 port. Apparently, the main drawback of the external card reader device is that it requires an additional device or interface to provide a connection port to couple to the outside. As more and more computer peripherals all rely on the same connection port of one specification, one usually have to decouple an already coupled device from the connection port and only after that can another device be coupled to the computer system. This creates inconvenience.

Moreover, an additional USB hub is usually needed as more and more computer peripherals (for example, a card reader device, mouse, keyboard and other human-machine interface device) all relying on the USB as the communication interface. In addition, a typical computer has a very limited number of USB connection ports available for connections. The USB hub is for managing information flow in/out of the USB card reader device and USB human-machine interface device to the computer system. Thus, the USB hub is also required in addition to the computer peripherals on the desktop. The additional USB hub also increases the complexities as both the numbers of elements and connections are increased in coupling the computer peripherals to the computer system.

Therefore, a multiple use device that serve to provide the functions described (under the condition that only a limited number of connection ports are available from a computer system and by not increasing the number of hardware devices) is desired and is the objective of the present invention.

### SUMMARY OF INVENTION

The present invention is to provide a device that integrates a card-reading function and an instruction-input function and an integrated chip therein, focussing on integration of hardware structural design and firmware control. The device is able to process both instruction-input from a human-machine interface and input/output from a memory card at the same time.

Another objective of the present invention is to provide an integrated chip placing inside the device described. The integrated chip combines the capabilities of a human-machine interface device, a card reader device and a USB hub that reduces the number of hardware devices required and cost.

The device for integrating the card-reading function and the instruction-input function, having a printed circuit board (PCB), a transmission interface on the printed circuit board for coupling to an external device, a memory card connector, a human-machine interface module and an integrated chip. The memory card connector is disposed on the printed circuit board for coupling a memory card and accessing the memory card. The human-machine interface module is also disposed on the printed circuit board for storing the outside-instruction and producing a break instruction when there is an input to the human-machine interface module. The integrated chip electrically couples to the transmission interface, the memory card connector and the human-machine interface module, wherein the integrated chip is capable of parallel processing input/output of the memory card connector and transmitting the break instruction from the human-machine interface module to the external device.

Wherein, the integrated chip for integrating a card-reading function and an instruction-input function further comprises an interface engine, a memory card interface module, a common input/output module, a memory module and a micro-controller. The interface engine electrically couples to the transmission interface. The memory card interface module electrically couples to the memory card connector. The common input/output module electrically couples to the human-machine interface module. The memory module stores read/write instructions and a concurrent program. Finally, the micro-controller electrically couples to the memory card interface module and the common input/output module. The micro-controller can process read/write instructions from the memory card at the same time execute input instruction by executing the concurrent program stored inside the memory module and communicate the outside.

Wherein, the interface engine provides serial and parallel data exchange for the transmission interface to the outside thus making the device suitable for external connection or internally built inside another device.

Moreover, the common input/output module supports interfaces including a button-type receiver, a wireless receiver, and an infrared receiver.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a device that integrates the card-reading function and the instruction input function as one preferred embodiment of the present invention.

FIG. 2 illustrates a human-machine interface module (compared to FIG. 1) as another preferred embodiment of the present invention.

FIG. 3 illustrates another human-machine interface module (compared to FIG. 1 and FIG. 2) as another preferred embodiment of the present invention.

FIG. 4 illustrates an integrated chip and structural design thereof as another preferred embodiment of the present invention.

FIG. 5 applies the integrated chip of FIG. 4 to FIG. 1 as another preferred embodiment of the present invention.

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

FIG. 1 illustrates a device that integrates the card-reading function and the instruction input function as one preferred embodiment of the present invention. Referring to FIG. 1, the device includes a cover (not shown in the drawings) and a printed circuit board (PCB) 10 disposed on the cover, a connection port 20 disposed on the printed circuit board 10 for coupling a transmission interface 100 to the outside. The transmission interface 100 can be a serial transmission interface, for example, a USB or IEEE1394, alternatively the transmission interface can also be a parallel transmission interface, for example, a parallel port.

In addition, a memory card connector 200, a human-machine interface module 300 and an integrated chip 400 are disposed on the printed circuit board 10 of the device. The integrated chip 400 electrically couples to the transmission interface 100, the memory card connector 200 and human-machine interface module 300. Thus, the integrated chip 400 is able to control information access from the memory card connector 200 and input instructions from the human-machine interface module 300 concurrently.

The elements within the printed circuit board 10 now are described more fully in the following paragraphs.

First, the memory card connector 200 allows a memory card 30 to plug-in and access information. As there are multiple specification of different memory cards (including PCMCIA, CF, MicroDrive, SDD/MMC, MS series, SM, xD) as supported by different vendors, the memory card connector 200 of the present invention provides multiple sockets supporting for at least two of the previous described specifications. Alternatively, the memory card connector 200 can also provide support for a single socket type containing 4-in-1 specification for memory cards.

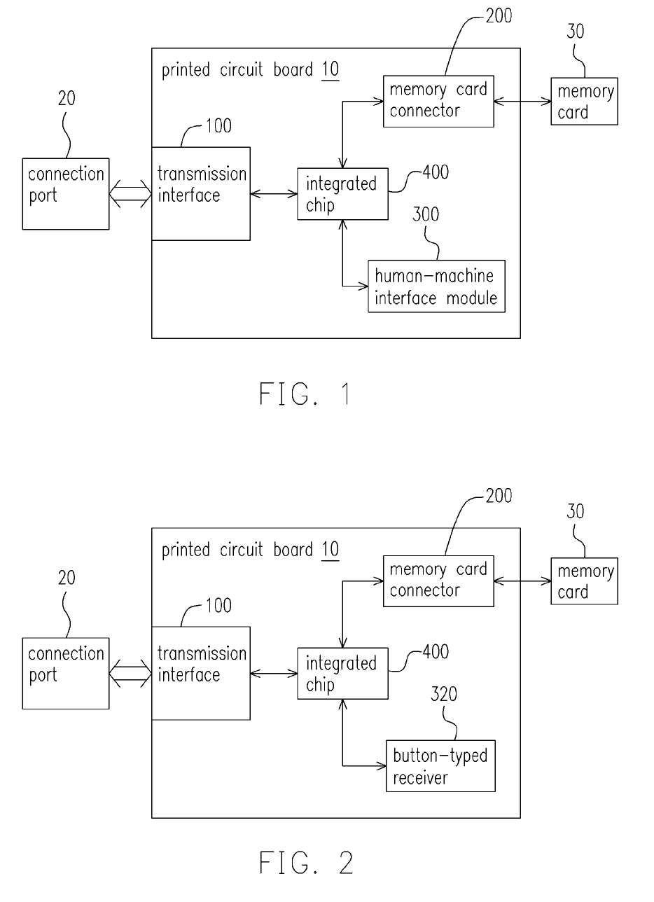

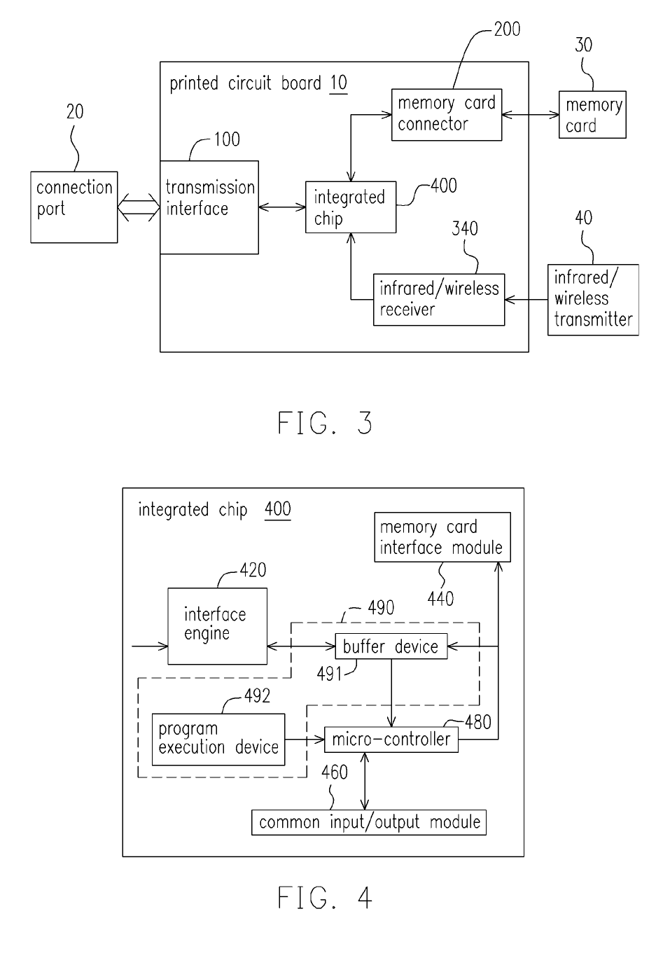

On the other hand, the human-machine interface module 300 produces a break instruction when there is an input signal from the outside, for example, a user. The human-machine interface module 300 can be a button-type receiver 320 (referring to FIG. 2) and a keyboard corresponds to the button-type receiver (not shown in the drawings) enabling a user to input instructions. In addition, the human-machine interface module 300 can also be a wireless/infrared receiver 340 (referring to FIG. 3) allowing a user to input instructions through a wireless/infrared transmitter 40.

The integrated chip 400 electrically couples to the memory card connector 200 and the human-machine interface module 300. So that the integrated chip 400 can access information from the memory card 30 through the memory card connector 200 and process the break instruction from the human-machine interface module 300. Moreover, the integrated chip 400 transmits information from the memory card 300 and input instructions from the human-machine interface module 300 to an external device through the connection port 20. The connection port electrically couples to the transmission interface 100.

The elements within FIG. 4 now are described more fully in the following paragraphs.

FIG. 4 illustrates an integrated chip and structural design thereof as another preferred embodiment of the present invention. Referring to FIG. 4, the integrated chip 400 includes an interface engine 420, a memory card interface module 440, a common input/output module 460, a memory module 490 and a micro-controller 480.

The interface engine 420 processes serial/parallel data exchange to the outside. The interface engine 420 uses data-packaging exchange (including instruction packaging, information packaging and response packaging) when the interface engine 420 is a parallel interface engine processing different formats of information. On the other hand, the interface engine 420 transfers serial signals from an external device to parallel signals when the interface engine 420 is a serial interface engine. Furthermore, the serial interface engine transfers parallel signals to serial signals when transmitting signals back to the external device.

The memory card interface module 440 supports at least one specification of a memory card and is the principle transmission medium for transmitting read/write data between the memory card 30 and an external device. The common input/output module 460 receives instructions from a user in accordance with different formats of input interface (including a button-type, a wireless and infrared input interfaces). The memory module 490 includes a buffer device 491 and a program execution device 492. The buffer device 491 electrically couples to the interface engine 420, the micro-controller 480 and the memory card interface module 440 for temporarily storing the read/write data between the memory card 30 and an external device. The program execution device 492 electrically couples to the micro-controller 480 for storing an execution program. The micro-controller 480 uses the execution program to control the operational concurrency.

The micro-controller 480 electrically couples to the memory card interface module 440, the common input/output module 460 and the memory module 490. In addition, the micro-controller 480 uses the execution program from the program execution device 492 to run the operations in the memory card interface module 440 and the common input/output module 460 concurrently. The operations include reading/writing data to the memory card 30 through the memory card interface module 440, and a break instruction from the common input/output module 460 through the interface engine 420 to an external device and producing an immediate response.

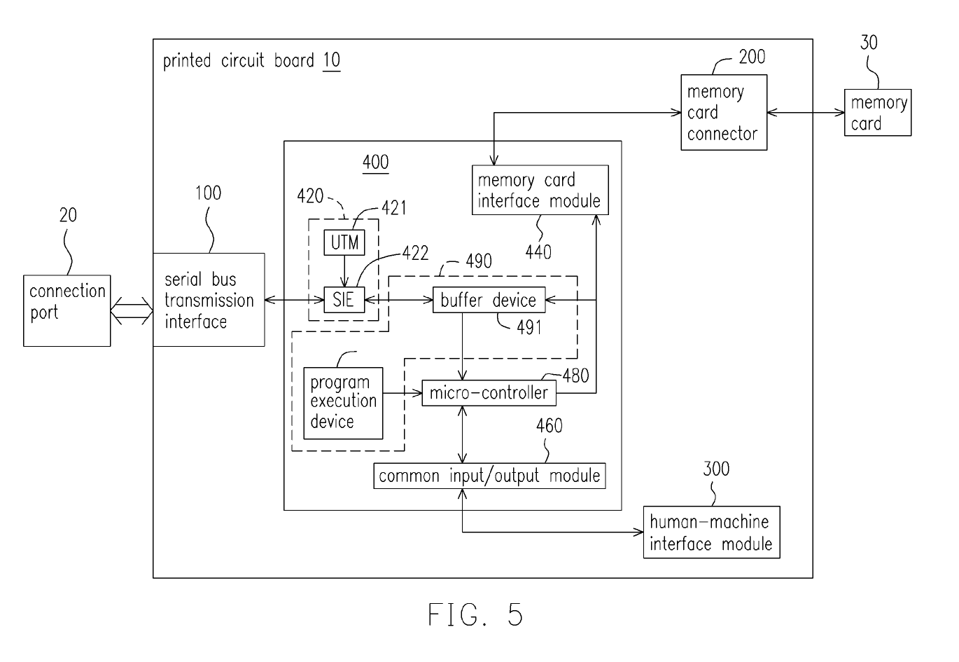

FIG. 5 applies the integrated chip of FIG. 4 to FIG. 1 as another preferred embodiment of the present invention. Referring to FIG. 5, the printed circuit board 10 of FIG. 5 uses an external transmission interface (for example, a universal serial bus interface) and a button-type input device for a human-machine interface. The button-type input device includes a mouse and a keyboard. The cover of the device incorporates the mouse and the keyboard.

Also referring to FIG. 5, a serial bus transmission interface 100, a memory card connector 200, a human-machine interface module 300 and an integrated chip 400 are disposed on the printed circuit board 10.

The integrated chip 400 includes an interface engine 420 electrically coupled to the universal serial bus transmission interface 100, a memory card interface module 440 electrically coupled to the memory card connector 200, a common input/output module electrically coupled to a human-machine interface module 300, a memory module 490 for storing the read/write data and an execution program for concurrency control and a micro-controller 480. The micro-controller 480 electrically couples to the memory card interface module 440, the common input/output module 460 and the memory module 490. In addition, the micro-controller 480 uses the execution program from the memory module 490 to process the read/write data of the memory card 30 and a break instruction of the button-type input device concurrently.

Because the interface engine 420 electrically couples with the USB transmission interface 100 and the USB interface includes two different versions in 1.1 and 2.0 at present. Thus, the interface engine 420 also includes a serial interface engine (SIE) 422 and a USB transceiver macrocell (UTM) 421 for processing the USB 1.1 and 2.0 version interfaces respectively.

In light of the above, the present invention provides a single integrated chip that can integrate multiple devices to one device and process operations concurrently with controlling ability for each of the operations.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A device capable of integrating a card-reading function and an instruction-input function, having a printed circuit board (PCB) and a transmission interface on the printed circuit board for coupling to an external device, comprising:
a memory card connector implemented on the printed circuit board for electrically coupling a memory card and accessing the memory card;
a human-machine interface module implemented on the printed circuit board for storing an outside-instruction and producing a break instruction; and
an integrated chip electrically coupling to the transmission interface, the memory card connector and the human-machine interface module, wherein the integrated chip is capable of parallel processing input/output of the memory card connector and transmitting the break instruction from the human-machine interface module to the external device.

2. The device of claim 1, wherein the transmission interface comprises a serial bus interface.

3. The device of claim 2, wherein the serial bus interface comprises a universal serial bus (USB) interface.

4. The device of claim 1, wherein the transmission interface comprises a parallel transmission interface.

5. The device of claim 4, wherein the parallel transmission interface comprises a parallel port.

6. The device of claim 1, wherein the memory card connector comprises at least one socket.

7. The device of claim 1 or claim 6, wherein the memory card connector is able to electrically couple to at least one of the many formats of a memory card.

8. The device of claim 1, wherein the human-machine interface module support devices including a button-type receiver, a wireless receiver, or an infrared receiver.

9. The device of claim 1, wherein the device further comprises a cover, and a keyboard or a mouse position corresponding to the button-type receiver on the cover as input media.

10. An integrated chip capable of integrating a card-reading function and an instruction-input function, comprising:
an interface engine, for processing serial/parallel information to an external device;
a memory card interface module, for transmitting an input/output from/to a memory card;
a common input/output module, for receiving a break instruction from one of the many different formats of an input interface;
a memory module electrically coupling to the interface engine, the memory card interface module for storing the input/output and a concurrent program; and
a micro-controller electrically coupling to the interface engine, the memory card interface module, and the common input/output module and the memory module for processing the input/output and the break instruction from the memory card interface module and the common input/output module, wherein the micro-controller controls the transmission between the memory module and the external device through the interface engine.

11. The integrated chip of claim 10, wherein the interface engine comprises a serial interface engine.

12. The integrated chip of claim 10, wherein the interface engine comprises a parallel interface engine.

13. The integrated chip of claim 10, wherein the memory module is further comprising:
a buffer device electrically coupling to the micro-controller and the memory card interface module for temporarily storing the input/output between the external device and the memory card; and
an program execution device electrically coupling to the micro-controller for storing the micro-controller's operational and concurrent program.

14. The integrated chip of claim 10, wherein the memory card interface module supports at least one of the many formats of a memory card.

15. The integrated chip of claim 10, wherein the common input/output module supports interfaces includes a button-type receiver, a wireless receiver, or an infrared receiver.
